(19) United States
(12) Patent Application Publication
(10) Pub. No.: US 2013/0163577 A1
(43) Pub. Date: Jun. 27, 2013

(54) POWER AMPLIFYING CIRCUIT AND WIRELESS COMMUNICATION DEVICE

(71) Applicant: JIAN-YAN FENG, Shenzhen City (CN)

(72) Inventor: JIAN-YAN FENG, Shenzhen City (CN)

(73) Assignees: CHI MEI COMMUNICATION SYSTEMS, INC., Tu-Cheng (TW); SHENZHEN FUTAIHONG PRECISION INDUSTRY CO., LTD., ShenZhen City (CN)

(21) Appl. No.: 13/523,906

(22) Filed: Jun. 15, 2012

(30) Foreign Application Priority Data
Dec. 26, 2011 (CN) 201110440966.3

(51) Int. Cl. H04W 88/02; H04B 7/216

(52) U.S. Cl. 370/342; 455/341

(57) ABSTRACT

A power amplifier circuit includes a first receiving switch, a first sending switch, and a power amplifier. The first receiving switch includes a first receiving switch terminal, a second receiving switch terminal, and a first receiving common terminal selectively connected to the first receiving switch terminal and the second receiving switch terminal The first sending switch includes a first sending switch terminal, a second sending switch terminal, and a first sending common terminal selectively connected to the first sending switch terminal and the second sending switch terminal. The power amplifier includes a first frequency band signal receiving terminal electrically connected to the first receiving common terminal, and a first frequency band signal sending terminal electrically connected to the first sending common terminal.

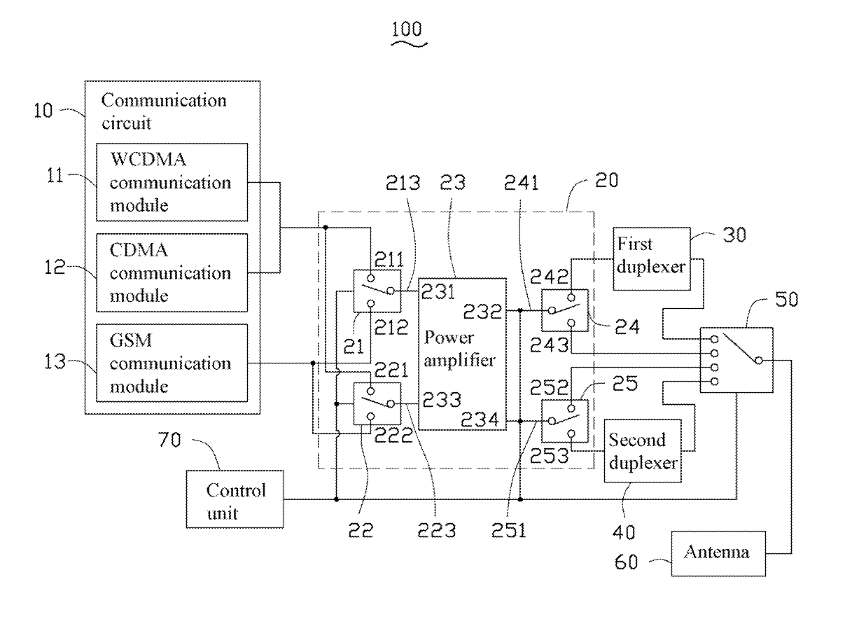

### BACKGROUND

1. Technical Field

The disclosure generally relates to power amplifying circuits, and particularly to a power amplifying circuit for a wireless communication device in multi-mode and multi-band communication systems.

2. Description of Related Art

A power amplifier is a necessary component for a wireless communication device to transmit radio frequency signals. To communicate in multi-mode and multi-band communication systems, the wireless communication usually includes multiple power amplifiers for different communication systems. However, the multiple power amplifiers may complicate a structure of the wireless communication device and increases cost of the wireless communication device.

Therefore, there is room for improvement within the art.

### BRIEF DESCRIPTION OF THE DRAWING

Many aspects of the present disclosure can be better understood with reference to the following drawing. The components in the drawing are not necessarily drawn to scale, the emphasis instead being placed upon clearly illustrating the principles of the disclosure.

The FIGURE is a partial circuit diagram of a wireless communication device, according to an exemplary embodiment of the disclosure.

### DETAILED DESCRIPTION

The FIGURE is a partial circuit diagram of a wireless communication device 100, according to an exemplary embodiment of the disclosure. The wireless communication device 100 includes a communication circuit 10, a power amplifying circuit 20, a first duplexer 30, a second duplexer 40, an antenna switch 50, an antenna 60 and a control unit 70.

The communication circuit 10 includes a WCDMA communication module 11, a CDMA communication module 12, and a GSM communication module 13. The WCDMA communication module 11 is configured for transmitting signals in the WCDMA850/900 frequency band and the WCDMA1800/1900 frequency band. The CDMA communication module 12 is configured for transmitting signals in the CDMA850/900 frequency band and the CDMA1800/1900 frequency band. The GSM communication module 13 is configured for transmitting signals in the GSM850/900 frequency band and the GSM1800/190 frequency band.

The power amplifying circuit 20 includes a first receiving switch 21, a second receiving switch 22, a power amplifier 23, a first sending switch 24, and a second sending switch 25.

The first receiving switch 21 includes a first receiving switch terminal 211, a second receiving switch terminal 212, and a first receiving common terminal 213. The first receiving switch terminal 211 is electrically connected to the WCDMA communication module 11 and the CDMA communication module 12 to receive the signals of WCDMA/CDMA850/900 frequency band. The second receiving switch terminal 212 is electrically connected to the GSM communication module 13 to receive the signals of GSM 850/900 frequency band. The first receiving common terminal 213 is electrically connected to the power amplifier 23 and the control unit 70. The first receiving common terminal 213 switches between the first receiving switch terminal 211 and the second receiving switch terminal 212 by control of the control unit 70 and selectively transmits the signals of WCDMA/CDMA850/900 frequency band or the signals of GSM 850/900 frequency band to the power amplifier 23.

The second receiving switch 22 is similarly connected to the first receiving switch 21. The second receiving switch 22 includes a third receiving switch terminal 221, a fourth receiving switch terminal 222, and a second receiving common terminal 223. The third receiving switch terminal 221 is electrically connected to the WCDMA communication module 11 and the CDMA communication module 12. The fourth receiving switch terminal 223 is electrically connected to the GSM communication module 13. The second receiving common terminal 223 is electrically connected to the power amplifier 23 and the control unit 70. The differences between the second receiving switch 22 and the first receiving switch 21 are that the third receiving switch terminal 221 receives the signals of WCDMA/CDMA1800/1900 frequency band, the fourth receiving switch terminal 222 receives the signals of GSM1800/1900 frequency band. The second receiving common terminal 223 selectively transmits the signals of WCDMA/CDMA1800/1900 frequency band or the signals of GSM1800/1900 frequency band to the power amplifier 23.

The power amplifier 23 is configured for amplifying the signals of WCDMA850/900 frequency band, WCDMA1800/1900 frequency band, CDMA850/900 frequency band, CDMA1800/1900 frequency band, GSM850/900 frequency band, and GSM1800/190 frequency band.

The power amplifier 23 includes a first frequency band signal receiving terminal 231, a first frequency band signal sending terminal 232 corresponding to the first frequency band signal receiving terminal 231, a second frequency band signal receiving terminal 233 and a second frequency band signal sending terminal 234 corresponding to the second frequency band signal receiving terminal 233.

The first frequency band signal receiving terminal 231 is electrically connected to the first receiving common terminal 213 to receive the signals of WCDMA/CDMA/GSM 850/900 frequency band and amplify the signals of WCDMA/CDMA/GSM 850/900 frequency band. The first frequency band signal sending terminal 232 is electrically connected to the first sending switch 24 and sends amplified signals of WCDMA/CDMA/GSM 850/900 frequency band to the first sending switch 24.

The second frequency band signal receiving terminal 233 is electrically connected to the second receiving common terminal 21 to receive and amplify the signals of WCDMA/CDMA/GSM 1800/1900 frequency band. The first frequency band signal sending terminal 232 is electrically connected to the second sending switch 25 and sends amplified signals of WCDMA/CDMA/GSM 1800/1900 frequency band to the second sending switch 25.

The first sending switch 24 includes a first sending common terminal 241, a first sending switch terminal 242 and a second sending switch terminal 243. The first sending common terminal 241 is electrically connected to the first frequency band signal sending terminal 232 to receive the amplified signals of WCDMA/CDMA/GSM 850/900 frequency band. The first sending switch terminal 242 is electrically connected to the antenna switch 50 via the first duplexer 30. The second sending switch terminal 243 is directly connected to the antenna switch 50.

The second sending switch 25 includes a second sending common terminal 251, a third sending switch terminal 252 and a fourth sending switch terminal 253. The second sending common terminal 251 is electrically connected to the second frequency band signal sending terminal 234 to receive the amplified signals of WCDMA/CDMA/GSM 1800/1900 frequency band. The third sending switch terminal 252 is directly connected to the antenna switch 50. The fourth sending switch terminal 253 is electrically connected to the antenna switch 50 via the second duplexer 40.

The control unit 70 is electrically connected to the first receiving switch 21, the second receiving switch 22, the first sending switch 24, the second sending switch 25 and the antenna switch 50 to control statuses of the first receiving switch 21, the second receiving switch 22, the first sending switch 24, the second sending switch 25 and the antenna switch 50 according to the communication mode and frequency band used by the wireless communication device 100.

When the WCDMA communication module 11 or the CDMA communication module 12 is used to transmit the signals of WCDMA/CDMA850/900 frequency band, the control unit 70 controls the first receiving common terminal 213 to switch to the first receiving switch terminal 211, and controls the first sending common terminal 241 to switch to the first sending switch terminal 242. Thus, the signals of WCDMA/CDMA850/900 frequency band can be amplified by the power amplifier 23, and transmitted to the antenna 60 by the first duplexer 30.

Accordingly, when the WCDMA communication module 11 or the CDMA communication module 12 is used to transmit the signals of WCDMA/CDMA1800/1900 frequency band, the control unit 70 controls the second receiving common terminal 233 to switch to the third receiving switch terminal 221, and controls the second sending common terminal 251 to switch to the third sending switch terminal 252.

When the GSM communication module 13 is used to transmit the signals of GSM 850/900 frequency band, the control unit 70 controls the first receiving common terminal 213 to switch to the second receiving switch terminal 212, and controls the first sending common terminal 241 to switch to the second sending switch terminal 243. Thus, the signals of GSM 850/900 frequency band can be amplified by the power amplifier 23, and transmitted to the antenna 60.

Accordingly, when the GSM communication module 13 is used to transmit the signals of GSM 1800/1900 frequency band, the control unit 70 controls the second receiving common terminal 223 to switch to the fourth receiving switch terminal 222, and controls the second sending common terminal 251 to switch to the fourth sending switch terminal 253.

The wireless communication device 100 uses the only one power amplifier 23 in different communication systems by controlling status of the switches to have a simplified structure and low cost.

It is believed that the exemplary embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. A power amplifying circuit, comprising:
a first receiving switch, the first receiving switch comprising:
a first receiving switch terminal;
a second receiving switch terminal; and
a first receiving common terminal selectively connected to the first receiving switch terminal and the second receiving switch terminal;
a first sending switch; the first sending switch comprising:
a first sending switch terminal;
a second sending switch terminal; and
a first sending common terminal selectively connected to the first sending switch terminal and the second sending switch terminal; and
a power amplifier, the power amplifier comprising:
a first frequency band signal receiving terminal electrically connected to the first receiving common terminal; and
a first frequency band signal sending terminal electrically connected to the first sending common terminal.

2. The power amplifying circuit of claim 1, further comprising a second receiving switch and a second sending switch, wherein the second receiving switch comprises a third receiving switch terminal, a fourth receiving switch terminal, and a second receiving common terminal selectively connected to the third receiving switch terminal and the fourth receiving switch terminal; the second sending switch comprises a third sending switch terminal, a fourth sending switch terminal, and a second sending common terminal selectively connected to the third sending switch terminal and the fourth sending switch terminal; the power amplifier further comprises a second frequency band signal receiving terminal electrically connected to the second receiving common terminal, and a second frequency band signal sending terminal electrically connected to the second sending common terminal.

3. A wireless communication device, comprising:
a communication circuit comprising a WCDMA communication module; a CDMA communication module; and a GSM communication module;
a power amplifying circuit, the power amplifying circuit comprising:
a first receiving switch, the first receiving switch comprising:
a first receiving switch terminal connected to the WCDMA communication module and the CDMA communication module;
a second receiving switch terminal connected to GSM communication module; and
a first receiving common terminal selectively connected to the first receiving switch terminal and the second receiving switch terminal;
a first sending switch; the first sending switch comprising:
a first sending switch terminal;
a second sending switch terminal; and
a first sending common terminal selectively connected to the first sending switch terminal and the second sending switch terminal; and
a power amplifier, the power amplifier comprising:
a first frequency band signal receiving terminal electrically connected to the first receiving common terminal; and
a first frequency band signal sending terminal electrically connected to the first receiving common terminal;
an control unit electrically connected to the first sending common terminal and the first receiving common terminal; and
an antenna electrically connected to the first sending switch terminal and the second sending switch terminal.

4. The wireless communication device of claim 3, wherein the power amplifying circuit further comprises a second receiving switch and a second sending switch, the second receiving switch further comprises a third receiving switch terminal, a fourth receiving switch terminal, and a second receiving common terminal selectively connected to the third receiving switch terminal and the fourth receiving switch terminal; the second sending switch comprises a third sending switch terminal, a fourth sending switch terminal, and a second sending common terminal selectively connected to the third sending switch terminal and the fourth sending switch terminal; the power amplifier further comprises a second frequency band signal receiving terminal electrically connected to the second receiving common terminal, and a second frequency band signal sending terminal electrically connected to the second sending common terminal.

5. The wireless communication device of claim 4, further comprising an antenna switch, wherein a first end of the antenna switch is selectively connected to the first, second, third and fourth sending switch terminals, a second end of the antenna is electrically connected to the antenna.

6. The wireless communication device of claim 5, further comprising a first duplexer connected between the first sending switch terminal and the antenna switch.

7. The wireless communication device of claim 5, further comprising a second duplexer connected between the fourth sending switch terminal and the antenna switch.
